(19) United States
(12) Patent Application Publication
(10) Pub. No.: US 2017/0093771 A1
(43) Pub. Date: Mar. 30, 2017

(54) ELECTRONIC MAIL CLUSTER ANALYSIS BY INTERNET HEADER INFORMATION

(71) Applicant: BANK OF AMERICA CORPORATION, Charlotte, NC (US)

(72) Inventors: Benjamin Lorenzo Gatti, Lake Park, NC (US); David Joseph Walsh, Fort Mill, SC (US); Jamison William Scheeres, Charlotte, NC (US); Nicholas Edward Peach, Charlotte, NC (US)

(21) Appl. No.: 14/871,554

(22) Filed: Sep. 30, 2015

(51) Int. Cl. H04L 12/58

(52) U.S. Cl. CPC H04L 51/12; H04L 51/22

(57) ABSTRACT

Systems, apparatus, and computer program products provide for analyzing/reading Internet message headers of emails to identify the source of the email and, in response to identifying the source, automatic grouping or clustering emails that have the same source, The grouping or cluster of emails may subsequently be investigated to determine if the emails pose a threat or are otherwise malicious. In specific embodiments of the invention the source of the email, along with other relevant grouping factors is use to further group/cluster emails. The other factors may include, but are not limited to, same subject of the email, same sender name, same sender email address, same links included in the email or the like. Additionally, embodiments of the present invention provide for automatically determining confidence scores for individual emails or groupings/clusters of emails based on the volume and/or type of suspicious indicators associated with the email or grouping of emails.

### FIELD

In general, embodiments of the invention relate to computing network communications and, more particularly, performing cluster analysis of electronic mail (email) by Internet message headers to identify the source of the email and grouping emails together having the same source to identify severity, in volume, of a potential email threat.

### BACKGROUND

Exploitable defects in popular operating systems and/or software applications are the means by which computer hackers penetrate network perimeters within enterprises and other computer network domains. Quite often, such malicious exploits make use of electronic mail (email) attachments or links in emails as the means by which the attack on the targeted network occurs. Targeted networks can expect to be exposed to various levels of email-related exploit attempts on an ongoing basis.

Entities that are responsible for investigating suspicious emails or emails known to pose a threat need to identify the size and/or scope of such incoming email-related threats in order to prioritize and allocate the proper resources to address the threat. In this regard, while previous acceptable response times for addressing a threat were upwards of twenty-four hours, the intensity of recent threats has lowered the acceptable response time to around one hour. In the case of email bound threats, investigative entities need to be able to readily assess how many individuals within the network domain have received the same or a similar email. What is referred to as cluster analysis is performed to automatically group or, otherwise cluster, emails that are the same similar. Typically such cluster analysis is performed by the subject of the email, as identified in the subject line; however, attackers seeking to be avoided have attempted to avert such analysis by frequently changing the subject lines of the email that pose a threat.

Therefore, a need exists to develop systems, apparatus, methods, computer program products and the like that automatically group same or similar emails or otherwise provide for email clusters for the purpose of performing investigation/managing threats posed by suspicious emails or emails known to pose a threat.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatus, computer program products or the like for analyzing/reading the Internet message header to identify the source (e.g., Internet Service Provider (ISP) or the like) of an email that is suspicious and, in response to identifying the source, automatically grouping or clustering emails that have the same source as an email. The grouping or cluster of emails is subsequently investigated for possible malicious threats or the like. In specific embodiments of the invention the source of the email, along with other relevant grouping factors is use to further group/cluster emails. The other factors may include, but are not limited to, same subject of the email, same sender name, same sender email address, same links included in the email or the like.

Additionally, embodiments of the present invention provide for automatically determining confidence scores for individual emails or groupings/clusters of emails based on the volume and/or type of suspicious indicators associated with the email or grouping of emails. The suspicious indicators may include, but are not limited to, inclusion within the email(s) of a link/URL (Uniform Resource Locator) that poses a known threat, email(s) having a hash value known to be associated with malware, and analysis performed by investigation entities indicates that the emails pose a threat. The confidence scores indicates the likelihood that (or confidence in) the emails pose threats or are otherwise malicious. As such, emails or groups of emails having a high volume of suspicious indicators and/or certain types of indicators may result in a high confidence score. In addition, embodiments of the invention provide for the confidence score to be continuously determined/updated based on the knowledge that the volume of indicators may change over time (i.e., an email that was previously considered benign can, over time, become malicious based on virus definitions/signatures being constantly updated).

A system for electronic mail (email) cluster analysis defines first embodiments of the invention. The system includes a plurality of email servers that store, in first memory electronic mail received by email addresses associated with specified domain. The system additionally includes a computing platform having a second memory and at least one processor in communication with the second memory. Additionally the system includes an email clustering module stored in the second memory, executable by the processor and configured to receive one or more suspicious electronic mails (emails) and analyze/read an internet message header of the one or more suspicious emails to identify a source of the suspicious email. In response the identifying the source and the emails with the same source, the module is further configured to group the emails having a same identified source into a first email cluster and store the cluster in memory.

In specific embodiments of the system, the email clustering module is further configured to analyze/read a subject line of the one or more suspicious emails to identify the subject of the suspicious email, in response to identifying the subject, group emails having the same identified source and same or similar subject into a second email cluster and store the second email cluster in memory.

In other specific embodiments of the system, the email clustering module is further configured to analyze/read a from line of the one or more suspicious emails to identify a sender name, and in response to identifying the sender name, group the emails having a same identified source and a same or similar sender name into a second email cluster and store the second email cluster in memory.

In still further specific embodiments of the system, the email clustering module is further configured to analyze/read a sender email address of the one or more suspicious emails to identify the sender email address, and, in response to identifying the sender email address, group the emails having a same identified source and a same or similar sender email address into a second email cluster and store the second email cluster in memory.

In additional specific embodiments of the system, the email clustering module is further configured to analyze/read a body of the suspicious email to identify one or more electronic links to a webpage, and, in response to identifying the links group emails having a same identified source and a same or similar electronic link into a second email cluster and store the second email cluster in memory.

Moreover, in further specific embodiments of the system, the email clustering module is further configured to analyze/read a subject line, a from line, a sender email address and a body of the email to identify a subject of the email, a name of a sender, a sender email address and one or more electronic links to a webpage included in the one or more suspicious emails, and, in response to identifying, group the emails having a same identified source and two or more of a same or similar (a) subject line), (b) sender name, (c) sender email address, (d) electronic link into a second email cluster and store the second email cluster in memory.

In further specific embodiments the system includes a confidence score module stored in the second memory, executable by the processor and configured to determine a confidence score for each email cluster based on at least one of a volume of suspicious indicators or a type of suspicious indicators associated with the email cluster. The suspicious indicators may include, but are not limited to, one or more of (a) inclusion of electronic links to webpages known for phishing, (b) inclusion of a hash value known to be associated with malware, and (c) internal investigation results in suspicion. The confidence score indicates a level of suspicion associated with an associated email cluster. In such embodiments of the system, the confidence score module may be further configured to determine, dynamically, the confidence score based on changes, over time, in the suspicious indicators.

A computer-implemented method for electronic mail (email) cluster analysis defines second embodiments of the invention. The method includes receiving, by a computing device processor, one or more electronic mails (emails), and analyzing, by a computing device processor, an internet message header of the one or more emails to identify a source of the email. In addition, the method includes accessing email servers to identify emails having a same source as the one or more suspicious emails. The method further includes grouping, by a computing device processor, the emails having a same identified source into a first email cluster and storing the first email cluster in memory for subsequent investigative purposes.

In specific embodiments the method further includes analyzing, by a computing device processor, one or more of (1) a subject line of the one or more suspicious emails to identify the subject, (2) a from line of the one or more suspicious emails to identify a sender name, (3) a sender email address of the one or more suspicious to identify the sender email address and (4) a body of the one or more suspicious emails to identify one or more electronic links to a webpage, and, in response to identifying, grouping, by a computer device processor, the emails having the same identified source and one or more of a same similar (1) subject, (2) sender name, (3) sender email address, and (4) electronic links to a webpage, into a second email cluster and storing the second email cluster in memory for subsequent investigative purposes.

In further embodiments the method includes determining, by a computing device processor, a confidence score for each email cluster based on at least one of a volume of suspicious indicators or a type of suspicious indicators associated with the email cluster. The confidence score indicates a level of suspicion associated with an associated email cluster. The suspicious indicators may include, but are not limited to, one or more of (a) inclusion of electronic links to webpages known for phishing, (b) inclusion of a hash value known to be associated with malware, and (c) internal investigation results in suspicion. In specific related embodiments determining the confidence score further includes determining dynamically, by the computing device processor, the confidence score based on changes, over time, in the suspicious indicators.

A computer program product including a non-transitory computer-readable medium defines third embodiments of the invention. The computer-readable medium includes a first set of codes for causing a computer to receive one or more electronic mails (emails). The computer-readable medium additionally includes a second set of codes for causing a computer to analyze an internet message header of the one or more emails to identify a source of the email. Additionally, the computer-readable medium includes a third set of codes for causing a computer to access email servers to identify emails having a same identifies source at the one or more suspicious emails. In addition the computer-readable medium includes a fourth set of codes for causing a computer to group the emails having a same identified source into a first email cluster and a fifth set of codes for storing the first email cluster in memory.

Thus, systems, apparatus, methods, and computer program products herein described in detail below provide for analyzing/reading Internet message headers of emails to identify the source of the email and, in response to identifying the source, automatic grouping or clustering emails that have the same source, The grouping or cluster of emails may subsequently be investigated to determine if the emails pose a threat or are otherwise malicious. In specific embodiments of the invention the source of the email, along with other relevant grouping factors is use to further group/cluster emails. The other factors may include, but are not limited to, same subject of the email, same sender name, same sender email address, same links included in the email or the like. Additionally, embodiments of the present invention provide for automatically determining confidence scores for individual emails or groupings/clusters of emails based on the volume and/or type of suspicious indicators associated with the email or grouping of emails.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a schematic view of a system for analyzing/reading Internet message headers of emails to identify the source of the email and, in response to identifying the source, grouping or clustering emails that have the same source, in accordance with embodiments of the present invention;

FIG. 2 provides a block diagram of an apparatus configured for analyzing/reading Internet message headers of emails to identify the source of the email and, in response to identifying the source, grouping or clustering emails that have the same source, in accordance with embodiments of the present invention; and

FIG. 3 provides a flow chart of a method for analyzing/reading Internet message headers of emails to identify the source of the email and, in response to identifying the source, grouping or clustering emails that have the same source, in accordance with present embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various systems, apparatus, methods, and computer program products are herein described for analyzing/reading the Internet message header to identify the source (e.g., Internet Service Provider (ISP) or the like) of an email that is suspicious and, in response to identifying the source, automatically grouping or clustering emails that have the same source as an email. The grouping or cluster of emails is subsequently investigated for possible malicious threats or the like. In specific embodiments of the invention the source of the email, along with other relevant grouping factors is use to further group/cluster emails. The other factors may include, but are not limited to, same subject of the email, same sender name, same sender email address, same links included in the email or the like.

Additionally, embodiments of the present invention provide for automatically determining confidence scores for individual emails or groupings/clusters of emails based on the volume and/or type of suspicious indicators associated with the email or grouping of emails. The suspicious indicators may include, but are not limited to, inclusion within the email(s) of a link/URL (Uniform Resource Locator) that poses a known threat, email(s) having a hash value known to be associated with malware, and analysis performed by investigation entities indicates that the emails pose a threat. The confidence scores indicates the likelihood that (or confidence in) the emails pose threats or are otherwise malicious. As such, emails or groups of emails having a high volume of suspicious indicators and/or certain types of indicators may result in a high confidence score. In addition, embodiments of the invention provide for the confidence score to be continuously determined/updated based on the knowledge that the volume of indicators may change over time (i.e., an email that was previously considered benign can, over time, become malicious based on virus definitions/signatures being constantly updated).

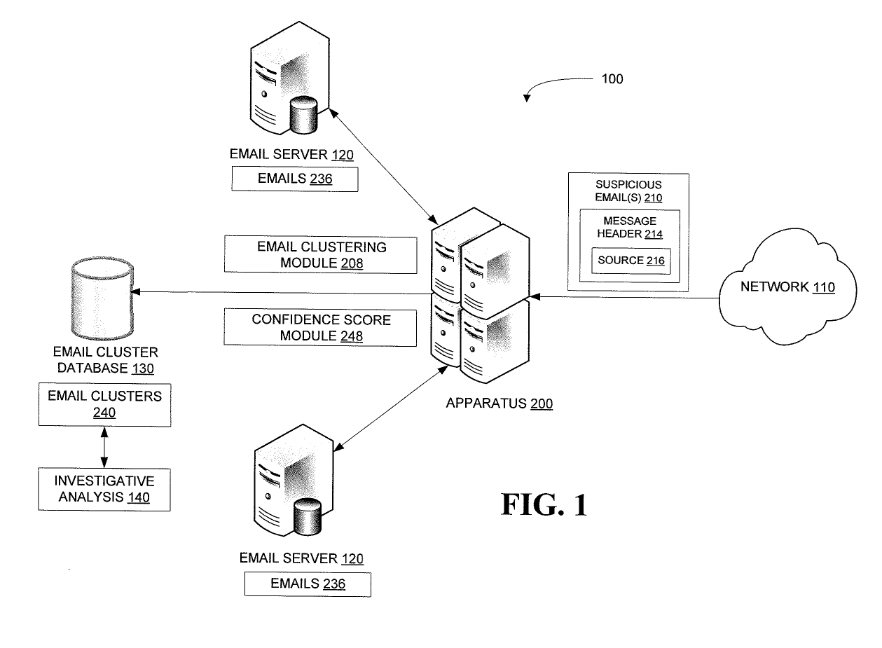

Referring to FIG. 1, a system 100 is shown for determining email clusters for suspicious investigative analysis, in accordance with embodiments of the present invention. The system includes an apparatus 200 that receives one or more suspicious emails 210 from a network 110. The network 110 may be an internal network, such as an intranet with an enterprise, such that the suspicious emails 210 are forwarded from individuals/entities within the enterprise that identify the emails 210 are being suspicious. In other embodiment of the invention, network 110 may be an external network, such as the Internet or the like, such that the suspicious emails 210 are identified upon receipt, at an email server or other email entryway to the enterprise.

Apparatus 200 stores, or has network access to, email clustering module 208, that is configured to, upon receipt of suspicious emails 210, analyze/read the Internet header message 214 of the suspicious emails 210 to identify the source 216 (Internet Service Provider (ISP) or the like). Once the source 216 of the suspicious email(s) 210 has been identified, the email clustering module 208, accesses email server(s) 120 to identify other emails 236 that have a same or similar source 216. In response to identifying the source 216 of the suspicious email(s) 210 and the other emails 236 having the same source 216, the email clustering module 208, groups, or otherwise clusters the emails into an email cluster 240 and stores the email cluster 240 in email cluster database 130 for subsequent investigative analysis 140 by an investigative entity for the purpose of determining if the emails in the cluster are malicious (e.g., contain a virus, malware or the like).

In alternate embodiments of the invention, apparatus 200 stores, or has network access to confidence score module 248 that is configured to determine a confidence score that indicates a level of suspicion associated with an email cluster (which may include on or more emails). The confidence score is determined based on volume or type of suspicious indicators associated with the email cluster. Suspicious indicators may include, but are not limited to, inclusion of links (e.g., Uniform Resource Locators (URLs) or the like) to webpages known for phishing, inclusion of hash values known to be associated with malware, internal investigation results in confirmed suspicion or the like.

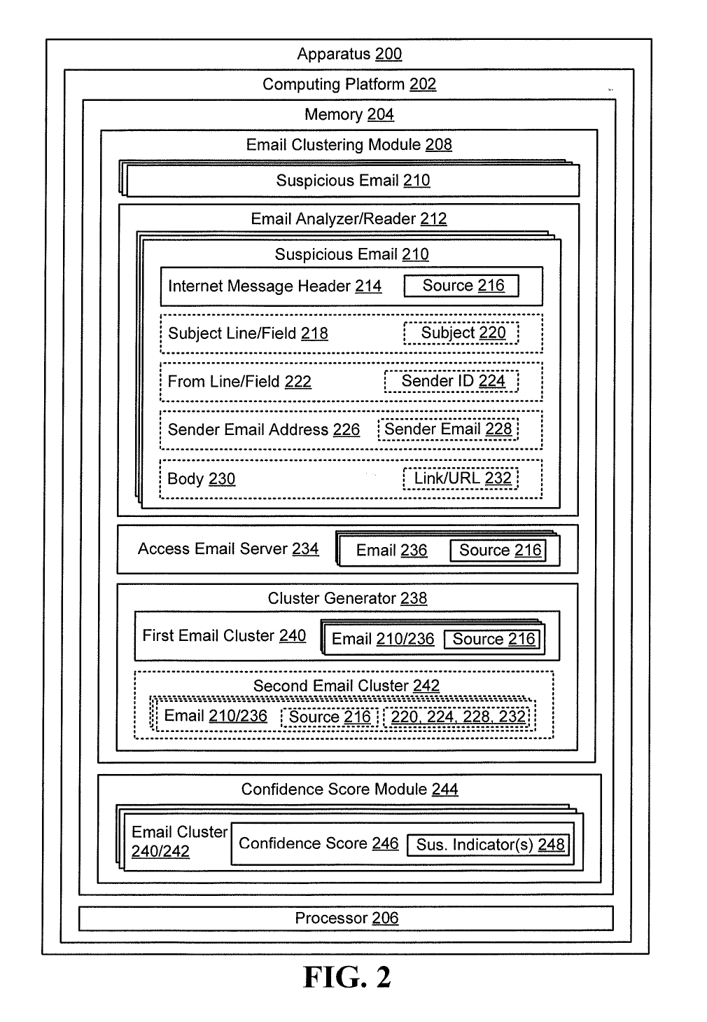

Referring to FIG. 2, a block diagram is presented of apparatus 200 configured for clustering emails based on Internet message header information, in accordance with embodiments of the present invention. The apparatus 200, which may comprise one or more computing devices, includes a computing platform 202 having a memory 204 and at least one processor 206 in communication with the memory 204.

Memory 204 may comprise volatile and non-volatile memory, such as read-only and/or random-access memory (RAM and ROM), EPROM, EEPROM, flash cards, or any memory common to computer platforms. Further, memory 204 may include one or more flash memory cells, or may be any secondary or tertiary storage device, such as magnetic media, optical media, tape, or soft or hard disk. Moreover, memory 204 may comprise cloud storage, such as provided by a cloud storage service and/or a cloud connection service.

Further, processor 206 may be an application-specific integrated circuit (“ASIC”), or other chipset, processor, logic circuit, or other data processing device. Processor 206 or other processor such as ASIC may execute an application programming interface (“API”) (not shown in FIG. 2) that interfaces with any resident programs or modules, such as email clustering module 208, confidence score module 244 and routines, sub-modules associated therewith or the like stored in the memory 204 of computing platform 202.

Processor 206 includes various processing subsystems (not shown in FIG. 2) embodied in hardware, firmware, software, and combinations thereof, that enable the functionality of email server apparatus 200 and the operability of the apparatus on a network. For example, processing subsystems allow for initiating and maintaining communications and exchanging data with other networked computing platforms, such as email recipient device 300 attachment storage 310, and logged access information storage 320 (shown in FIG. 1). For the disclosed aspects, processing subsystems of processor 206 may include any subsystem used in conjunction with email clustering module 208, confidence score module 244 and related algorithms, sub-algorithms, modules, sub-modules thereof.

Computer platform 202 may additionally include a communications module (not shown in FIG. 2) embodied in hardware, firmware, software, and combinations thereof, that enables communications among the various components of the computing platform 202, as well as between the other networked devices. Thus, communication module may include the requisite hardware, firmware, software and/or combinations thereof for establishing and maintaining a network communication connection with other devices, such as email servers 120 and/or email cluster database 130 (shown in FIG. 1) and the like.

The memory 106 of email server apparatus 200 stores email clustering 208. In other embodiments of the invention, email clustering module 208 may be stored in other external memory that is accessible to apparatus 200. Email clustering module 208 is configured to receive one or more suspicious emails 210 from an intranet, e.g., an internal email mailbox/internal email recipient or in some embodiments from an external network, such as the internet or the like.

Upon receipt of the suspicious emails 210, email clustering module 208 is configured to implement email analyzer/reader 212 to analyze/read the Internet message header for relevant information, including a source 216 (e.g., ISP or the like) of the suspicious email 210. In additional embodiments of the invention, email analyzer/reader 212 is configured to analyze/read other portions of the email including, but not necessarily limited to, the subject line 218 of the suspicious emails 210 to identify the subject 220; the from line 222 of the suspicious emails 210 to identify the sender name or identifier 224; the sender email address field 226 of the suspicious emails 228 to identify the sender email address 228; and the body 230 of the suspicious emails 210 to identify links/URLs included in the body 230 of the suspicious emails 210.

In response to identifying the source 216 of the suspicious email 210, the email clustering module 208 is configured to access the email servers 234 within the domain/enterprise to identify other emails 236 having the same, and in some embodiments a similar, source 216 as the source 216 identified in the suspicious emails 210. In response to identifying the other emails 236 having the same source 216, email clustering module invokes email cluster generator 238 that is configured to group, or otherwise cluster the emails 210 and 236 having the same source 216 into a first email cluster 240 and store the first email cluster 240 in the email cluster database 130 (shown in FIG. 1).

In alternate embodiments of the invention, the email cluster generator 238 is configured to group. Or otherwise cluster the emails 210 and 236 having the same source 216 ant, at least, one of same, or in some embodiments similar, subject 220, sender name/identifier 224, sender email address 228 and/or link(s)/URL(s) into a second email cluster 242 and store the second email cluster(s) in email cluster database 130 (shown in FIG. 1).

As previously noted, the stored email clusters are subsequently used by investigation entities for investigative analysis for the purpose of discerning whether the emails in the email cluster 240 and/or 242 are malicious or otherwise harmful.

In additional embodiments of the invention, memory 204 of apparatus 200 stores confidence score module 244 that is configured to determine a confidence score 246 for email clusters 240 and 242 that indicates a level of suspicion associated with the email clusters. It should be noted that an email cluster may comprise a single emails, in which case, the confidence score may be associated with the single email. The confidence score is based on suspicious indicators 248 associated with the email cluster 240/242 and specifically, the volume and/or type of suspicious indicators 248 associated with the email cluster 240, 242. As noted above, the suspicious indicators 248 may include, but are not necessarily limited to, inclusion of links (e.g., Uniform Resource Locators (URLs) or the like) to webpages known for phishing, inclusion of hash values known to be associated with malware, internal investigation results in confirmed suspicion or the like. Moreover, the confidence score may be dynamically determined or updated based on the fact that the suspicious indicators may change over time (e.g., an email that was originally thought to be benign is determined to be malicious due to current definitions of viruses, malware or the like).

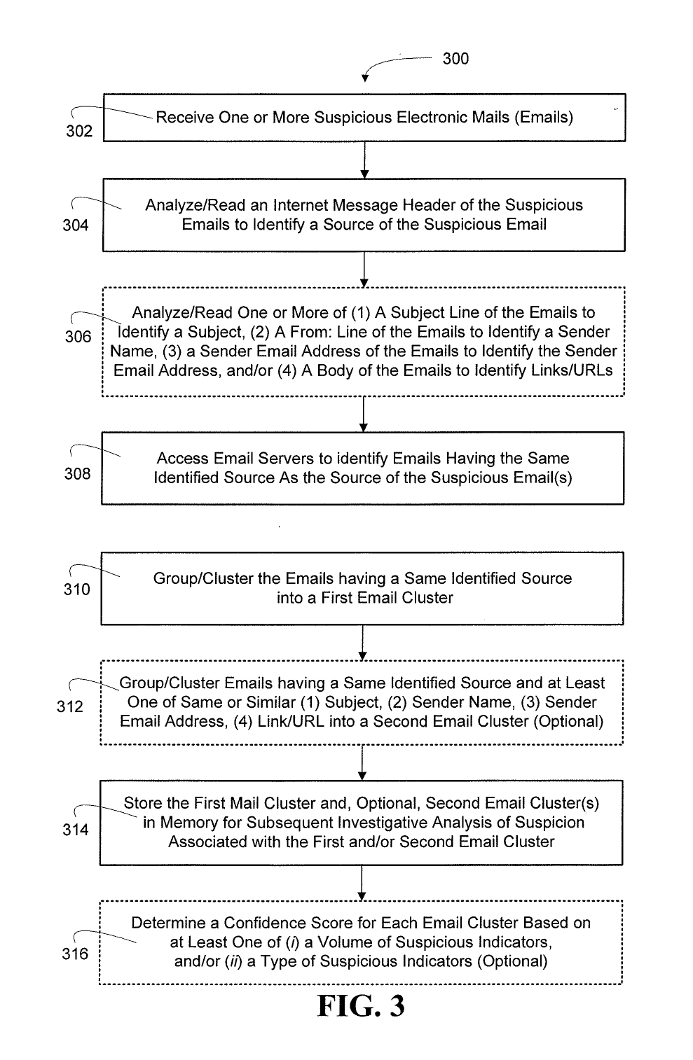

Referring to FIG. 3, a flow diagram is presented of a method 300 for grouping/clustering emails based on Internet message header information, in accordance with embodiments of the present invention. At Event 302, one or more suspicious emails are received from an internal source, such as an email mailbox/email recipient or, alternatively, from an external source, Internet or the like. At Event 304, the Internet message header of the suspicious email(s) is analyzed/read to identify relevant information, including the source (e.g., ISP or the like) of the suspicious email(s). At optional Event 306, other portions of the suspicious emails are read/analyzed, for example, the subject line of the suspicious emails may be read to identify the subject of the emails(s); the from line may be read to identify the sender name or identifier of the email(s); the sender's email address may be read to identify the email address of the sender; and the body of the email(s) may be read/analyzed to identify any links or URLs in the email(s).

In response to identifying the source of the suspicious emails, at Event 308, the email server(s) are accessed to identify other emails that have the same, or in some embodiments a similar, source as the source of the suspicious email(s). In response to identifying the other emails having the same or similar source, at Event 310, the emails having the same or similar sources are grouped or clustered to form a first email cluster. Additionally, in some embodiments of the invention, at optional Event 312, the emails having the same source and at least one of same/similar subject, same/similar, sender, same/similar sender email address and/or same/similar link(s)/URL(s) are grouped or otherwise clustered for form second email clusters. At Event 314, the first and second email clusters are stored in computing device memory for subsequent investigative analysis for the purpose of determining if the emails in the cluster are malicious or otherwise harmful.

At optional Event 316, a confidence score is determined for the email clusters that indicates a level of suspicion associated with the email cluster. The confidence score may be based on the volume and/or type of suspicious indicators associated with the email cluster. The suspicious indicators may include, but are not necessarily limited to, inclusion of links (e.g., Uniform Resource Locators (URLs) or the like) to webpages known for phishing, inclusion of hash values known to be associated with malware, internal investigation results in confirmed suspicion or the like. Moreover, the confidence score may be dynamically determined or updated based on the fact that the suspicious indicators may change over time (e.g., an email that was originally thought to be benign is determined to be malicious due to current definitions of viruses, malware or the like).

Thus, systems, apparatus, methods, and computer program products described above provide for analyzing/reading Internet message headers of emails to identify the source of the email and, in response to identifying the source, automatic grouping or clustering emails that have the same source, The grouping or cluster of emails may subsequently be investigated to determine if the emails pose a threat or are otherwise malicious. In specific embodiments of the invention the source of the email, along with other relevant grouping factors is use to further group/cluster emails. The other factors may include, but are not limited to, same subject of the email, same sender name, same sender email address, same links included in the email or the like. Additionally, embodiments of the present invention provide for automatically determining confidence scores for individual emails or groupings/clusters of emails based on the volume and/or type of suspicious indicators associated with the email or grouping of emails.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for electronic mail (email) cluster analysis, the system comprising:
a plurality of email servers that store, in first memory electronic mail received by email addresses associated with a specified domain;
a computing platform having a second memory and at least one processor in communication with the second memory; and
an email clustering module stored in the second memory, executable by the processor and configured to:
receive one or more suspicious electronic mails (emails),
analyze an internet message header of the one or more suspicious emails to identify a source of the suspicious email,
access the email servers to identify emails having a same identified source as the one or more suspicious emails,
group the emails having the same identified source into a first email cluster, and
store the first email cluster for subsequent investigative analysis of suspicion associated with the first email cluster.

2. The system of claim 1, wherein the email clustering module is further configured to:
analyze a subject line of the one or more suspicious emails to identify the subject of the suspicious email,
group the emails having the same identified source and same or similar subject into a second email cluster, and
store the second email cluster for subsequent investigative analysis of suspicion associated with the second email cluster.

3. The system of claim 1, wherein the email clustering module is further configured to:
analyze a from: line of the one or more suspicious emails to identify a sender name,
group the emails having a same identified source and a same or similar sender name into a second email cluster, and
store the second email cluster for subsequent investigative analysis of suspicion associated with the second email cluster.

4. The system of claim 1, wherein the email clustering module is further configured to:
analyze a sender email address of the one or more suspicious emails to identify the sender email address,
group emails having a same identified source and a same or similar sender email address into a second email cluster, and
store the second email cluster for subsequent investigative analysis of suspicion associated with the second email cluster.

5. The system of claim 1, wherein the email clustering module is further configured to:
analyze a body of the one or more suspicious emails to identify one or more electronic links to a webpage,
group the emails having a same identified source and a same or similar electronic link into a second email cluster, and
store the second email cluster for subsequent investigative analysis of suspicion associated with the second email cluster.

6. The system of claim 1, wherein the email clustering module is further configured to:
analyze a subject line, a from line, a sender email address and a body of the one or more suspicious emails to identify a subject of the email, a name of a sender, a sender email address and one or more electronic links to a webpage included in the one or more suspicious emails,
group the emails having a same identified source and two or more of a same or similar (a) subject line), (b) sender name, (c) sender email address, (d) electronic link into a second email cluster, and
store the second email cluster for subsequent investigative analysis of suspicion associated with the second email cluster.

7. The system of claim 1, wherein the email clustering module is further configured to receive the one or more suspicious emails in response to an email recipient reporting one of the emails as suspicious.

8. The system of claim 1, further comprising a confidence score module stored in the second memory, executable by the processor and configured to determine a confidence score for each email cluster based on at least one of a volume of suspicious indicators or a type of suspicious indicators associated with the email cluster, wherein the confidence score indicates a level of suspicion associated with an associated email cluster.

9. The system of claim 8, wherein the confidence score module is further configured to determine, dynamically, the confidence score based on changes, over time, in the suspicious indicators.

10. The system of claim 8, wherein the confidence score module is further configured to determine the confidence score for each email cluster based on at least one of the volume of suspicious indicators or the type of suspicious indicators associated with the email cluster, wherein the suspicious indicators include one or more of (a) inclusion of electronic links to webpages known for phishing, (b) inclusion of a hash value known to be associated with malware, and (c) internal investigation results in suspicion.

11. A computer-implemented method for electronic mail (email) cluster analysis, the system comprising:
receiving, by a computing device processor, one or more suspicious electronic mails (emails);
analyzing, by a computing device processor, an internet message header of the one or more suspicious emails to identify a source of the suspicious email;
accessing, by a computing device processor, email servers to identify emails having a same identified source as the one or more suspicious emails and
grouping, by a computing device processor, the emails having the same identified source into a first email cluster; and
storing, in computing device memory, the first email cluster for subsequent investigative analysis of suspicion associated with the first email cluster.

12. The method of claim 11, further comprising:
analyzing, by a computing device processor, one or more of (1) a subject line of the one or more suspicious emails to identify the subject, (2) a from line of the one or more suspicious emails to identify a sender name, (3) a sender email address of the one or more suspicious emails to identify the sender email address, and (4) a body of the one or more suspicious emails to identify one or more electronic links to a webpage,
grouping, by a computer device processor, the emails having the same identified source and at least one of same or similar (1) subject, (2) sender name, (3) sender email address, and (4) electronic links to a webpage, into a second email cluster, and
storing, in computing device memory, the second email cluster for subsequent investigative analysis of suspicion associated with the second email cluster.

13. The method of claim 11, wherein receiving the suspicious emails further comprises receiving, by the computing device processor, the one or more suspicious emails in response to an email recipient reporting one of the emails as suspicious.

14. The method of claim 1, further comprising determining, by a computing device processor, a confidence score for each email cluster based on at least one of a volume of suspicious indicators or a type of suspicious indicators associated with the email cluster, wherein the confidence score indicates a level of suspicion associated with an associated email cluster.

15. The method of claim 14, wherein determining the confidence score further comprises determining dynamically, by the computing device processor, the confidence score based on changes, over time, in the suspicious indicators.

16. The method of claim 14, wherein determining the confidence score further comprises determining, by the computing device processor, the confidence score for each email cluster based on at least one of the volume of suspicious indicators or the type of suspicious indicators associated with the email cluster, wherein the suspicious indicators include one or more of (a) inclusion of electronic links to webpages known for phishing, (b) inclusion of a hash value known to be associated with malware, and (c) internal investigation results in suspicion.

17. A computer program product comprising:
a non-transitory computer-readable medium comprising:
a first set of codes for causing a computer to receive one or more suspicious electronic mails (emails);
a second set of codes for causing a computer to analyze an internet message header of the one or more suspicious emails to identify a source of the suspicious email;
a third set of codes for causing a computer to access email servers to identify emails having a same identified source as the one or more suspicious emails;
a fourth set of codes for causing a computer to group emails having a same identified source into a first email cluster; and
a fifth set of codes for causing a computer to store the first email cluster for subsequent investigative analysis of suspicion.

18. The computer program product of claim 17, further comprising:
a sixth set of codes for causing a computer to analyze one or more of (1) a subject line of the one or more suspicious emails to identify the subject, (2) a from line of the one or more suspicious emails to identify a sender name, (3) a sender email address of the one or more suspicious emails to identify the sender email address and (4) a body of the one or more suspicious emails to identify one or more electronic links to a webpage;
a seventh set of codes for causing a computer to group the emails having the same identified source and at least one of same or similar (1) subject, (2) sender name, (3) sender email address, and (4) electronic links to a webpage, into a second email cluster; and
an eighth set of codes for causing a computer to store the second email cluster for subsequent investigative analysis of suspicion associated with the second email cluster.

19. The computer program product of claim 17, further comprising a sixth set of codes for causing a computer to determine a confidence score for each email cluster based on at least one of a volume of suspicious indicators or a type of suspicious indicators associated with the email cluster, wherein the confidence score indicates a level of suspicion associated with an associated email cluster.

20. The computer program product of claim 19, wherein the sixth set of codes is further configured to cause the computer to determine dynamically the confidence score based on changes, over time, in the suspicious indicators.
